(19) United States
(12) Patent Application Publication
(10) Pub. No.: US 2016/0086072 A1
(43) Pub. Date: Mar. 24, 2016

(54) PERSONALIZED BARCODE INFORMATION TRANSFER

(71) Applicant: Anthony Castillo, Orlando, FL (US)

(72) Inventor: Anthony Castillo, Orlando, FL (US)

(73) Assignee: Anthony Castillo, Orlando, FL (US)

(21) Appl. No.: 14/161,541

(22) Filed: Jan. 22, 2014

(51) Int. Cl. G06K 19/06; G06K 7/14

(52) U.S. Cl. CPC G06K 19/06037; G06K 7/1443

(57) ABSTRACT

A system, method and computer program product for optically transferring data from a mobile electronic device to a computer system and memory storage unit using barcoded data. The data transferring method encodes the data into a barcode. The barcode is displayed on the mobile device display. A user directs the mobile electronic device display at a visual capture device which captures the barcoded data. The barcode pattern is then decoded into the originating data information for computer processing.

### CROSS-REFERENCES TO RELATED APPLICATIONS

This application claims the benefit of provision patent application Ser. No. 61/756,122, filed 24 Jan. 2013.

### FEDERALLY SPONSORED RESEARCH

None

### SEQUENCE LISTING

None

### BACKGROUND

### Prior Art

The following is a listing of some prior art that presently appears relevant:
U.S. Pat. No. 8,348,164—“Information processing apparatus, information processing method, program and information processing system”—This invention includes a communication unit for transmitting a carrier wave. I do not use any carrier wave method.
U.S. Patent 20110000958—“Systems and Methods for Animating Barcodes”—Is a method and system of linking barcodes together in successive format to encode a string of information. I don't link barcodes together.
U.S. Pat. No. 7,434,724—“Dynamic barcode for displaying medical data”—This invention relates solely with medical data that interacts with medical sensors but does not include interaction from a cell phone.
U.S. Pat. No. 7,693,744—“Optimised messages containing barcode information for mobile receiving devices”—this system specifically delivers coupons containing barcodes to a mobile device such as a mobile phone. It does not, however, include barcodes containing coupon information. U.S. Pat. No. 8,348,149—“Using dynamic barcodes to send data to a cell phone”—This invention relates to a cell phone user reading barcodes with their cell phone and camera. The user would record video containing a barcode that can then be decoded and send the user to a URL.
U.S. Pat. No. 8,033,469—“Apparatus for performing multimedia”—based data transmission and associated method—refers strictly to multimedia-based data transmission
U.S. Pat. No. 8,038,054—“Method of using an indicia reader”—Deals strictly with transaction authorization
U.S. Patent 20070102521—“Method and system for using barcoded contact information for compatible use with various software”—Deals strictly with business card or other printed material.
U.S. Patent 20060289654—“Method and system for linking a wireless hand held optical reader with a base unit or other wireless device”—This is an invention that relates specifically to linking of wireless hand held optical readers. My invention does uses but does not claim an invention on optical readers.

The convenience of Smartphones (to include mobile phone, cell phones, other capable electronic devices) has made it easier for the users to interact with businesses in new and more efficient ways. The addition of Bluetooth capabilities, on these devices, allows a Smartphone user to send information to another compatible Bluetooth receiver, only after a time consuming pairing and authentication have taken place. The process by which is not always straight forward and has many other disadvantages such as battery drain, making sure the Smartphone device has the Bluetooth feature enabled, and also requires a consumer who is very familiar with the Bluetooth feature as well as their Smartphone capabilities. An alternative that would offer the ability to transfer information without these limitations would be beneficial.

With the introduction of 2D barcodes, such as QR Code or Data Matrix, for everyday use, businesses can now share information with consumers, such as website URL's, in an easily accessible format on their Smartphone screens. Normally, through the use of barcode reading applications, a Smartphone user is able to decode the barcode information along with the added feature of automatically launching the website that the business wants to send to the consumer. However, this combination of a Smartphone and 2D barcodes can have a more powerful and profound use of information sharing that could go further than that or similar examples.

While the previous example of a one-way transfer of information from the business to the consumer has proven to work with small amounts of information to be shared, the data capacity of the 2D barcode actually allows for much greater transfer of information both from the business to the consumer as well as information sharing from the consumer to the business, if used in an efficient and optimized manner. By enabling and allowing a Smartphone user to create their own 2D barcode, the business entity, or information sharer, can benefit and the consumer will benefit by transferring personalized data in a quick and precise manner.

Previous methods of sending information via mobile phone or portable devices to short range locations, involve the use of radio or internet methods which suffer from a number of known disadvantages:
a) They are prone to interference from other electronic sources
b) They are prone to electronic eavesdropping
c) Require an active internet connection
d) Require a Bluetooth connection which requires a time consuming pairing method
e) Require resources that drain battery power at an expanded rate

The solution contains software to allow a Smartphone to create 2D barcodes containing the information to be share, a 2D barcode reader for reading the Smartphone 2D barcode, a host computer connected to the 2D barcode reader or optical device, and host computer software to manipulate the data for display or further processing.

### SUMMARY

In accordance with one embodiment, a Smartphone contains the custom software application to create a unique barcode containing information to be transferred. This information can contain an order for food, for example, that is shared with a restaurant. The software application contains a menu driven input method to conclude with a 2D barcode of the customer's order including all the order details. This 2D barcode will then be displayed on the Smartphone device ready to be read by the business 2D barcode reader. The business 2D barcode reader can include the optical reader, camera, barcode detector device and other similar devices. The information is then sent to the host computer (such as a point of sale computer), via the business 2D barcode reader, for processing and decoding of the actual order items and quantities to include any special requests, modifications and discounts or adjustments. The host computer, with the custom 2D decoding software, receives the information and decodes the actual order. With the order now in the host computer, this completes the point of sale order processing. In other embodiments, the order is sent to another point of sale or processing destination as needed.

A second embodiment of this solution involves a user inputting their personal information into the Smartphone custom software application, in order to create a 2D barcode that contains this same information that will complete a form application such as one would normally fill out at a medical, job or service location. Details such as name, address, zip code, phone number, previous addresses, and any other requested information is combined on the smartphone and creates a 2D barcode, to then be read by the 2D barcode scanner that the business, or other entity, possesses for this purpose. Once the 2D barcode is read by the host computer, the information contained in the 2D barcode is transferred into the host computer for display, saving, and/or processing on said computer or can also be sent to other processing computers systems.

If the information is too large to create a readable sized 2D barcode, the software is capable of segmenting the information into parts with each part encoded into its own barcode and then combined at the host computer side. The first segmented part would be created on a 2D barcode that saves a portion of the 2D barcode to indicate that a second 2D barcode is expected with further text is requested to be transferred. The second 2D barcode would also indicate it is a second 2D barcode in a series. This process of continuous barcodes can continue until all the data is available in barcode format, for transfer. Each successive barcode will indicate it is the next in the series and the final barcode will indicate that no further data is required. Once the Smartphone application creates the 2D barcode, it will display the 2D barcodes on the screen while the 2D barcode reader reads each one and sends the information to the host computer for processing. The host computer will receive the multiple barcodes and proceed to decode or process the information for the display or next processing system.

In any embodiment, the barcode data itself could be comprised of the full text data wording such as “Super Burger Deluxe Baconator, quantity 1, price $9.99” or a coded version relating back to the item such as “SBDB,1,9.99”. Further improvements such as “S1AN” where S1 is the Super Burger Deluxe Baconator”, A is the standard quantity of 1, and N is a no adjustment to price code. Data could also be processed to a cross-reference database for quicker processing and possible encryption of data and privacy concerns. Identifier or encryption code or codes may also be included in the data or string to assist in the decoding.

### Advantages

By ordering from a Smartphone, the user has the advantage of viewing the menu of items locally, to place an order, before arriving at the food establishment. This feature will allow a user to save the food order from a software application and simply present it once ready to order by scanning the user created barcode. This may include frequently requested items the user prefers and orders on a regular basis, thereby allowing the user to save the order for quick access on a next visit. The order consists of, but is not limited to, such items as item name, quantity, price and discounts.

The advantage for a user using the second embodiment allows the user to input the exact data they want or are requested to share, and need only to input each piece of information into the Smartphone one time and can save for future use and for quick access. Filling out applications, is time consuming and a repetitive process. Often times the requirement for the same information is requested multiple times on different pages or even on the same page. This embodiment also allows for input, at anytime thus allowing the information to be ready to create a 2D barcode, for data sharing, once at the scanning location at a business office or similar. The user has the ability to save and recall the information. The information consists of, but is not limited to, such information as name, address, city, date of birth, previous address, employment, education, medical, background, history, miscellaneous and any other information the user wishes to share or transfer.

The custom software application will allow the user to have the information locally stored on the Smartphone itself. The software can have the ability to encrypt the information prior to creating the barcode and the host computer can decrypt as needed. Encryption or not, the user has the option to create the barcode at the users discretion and at any time. The software can also exist on a server, such as accessible through the internet, available for direct input onto a website or downloadable locally, that can communicate and transfer to the users Smartphone application for storage and use. This will allow a user who prefers typing onto a keyboard to use this method and transfer to their Smartphone for use of the solution. This is especially useful for those users who are not able to use the limited keyboard capacity of a Smartphone or similar device.

Thus several advantages of one or more aspects are that the customized 2D barcode displayed on a device is a more secure method of information transfer. Other advantages of one or more aspects are that the 2D barcode display on a device is more convenient. These and other advantages of one or more aspects will become apparent from a consideration of the ensuing description and accompanying drawings.

### BRIEF DESCRIPTION OF THE DRAWINGS

FIG. 1 is a flow chart showing the method for generating 2D barcodes for food ordering off of a menu driven mobile application.

FIG. 2 is a flow chart showing the method for generating 2D barcodes off of a user input driven mobile application.

FIG. 3 is a flow chart showing a method for recovering data from a 2d barcode from a mobile phone application

FIG. 4 illustrates an overview of the food ordering process with this solution.

FIG. 5 illustrates an overview of the information input embodiment method. In this case the user is at an office visit and has been asked to fill out an application of information however opts to complete the information via Smartphone data transfer with this embodiment.

### DETAILED DESCRIPTION

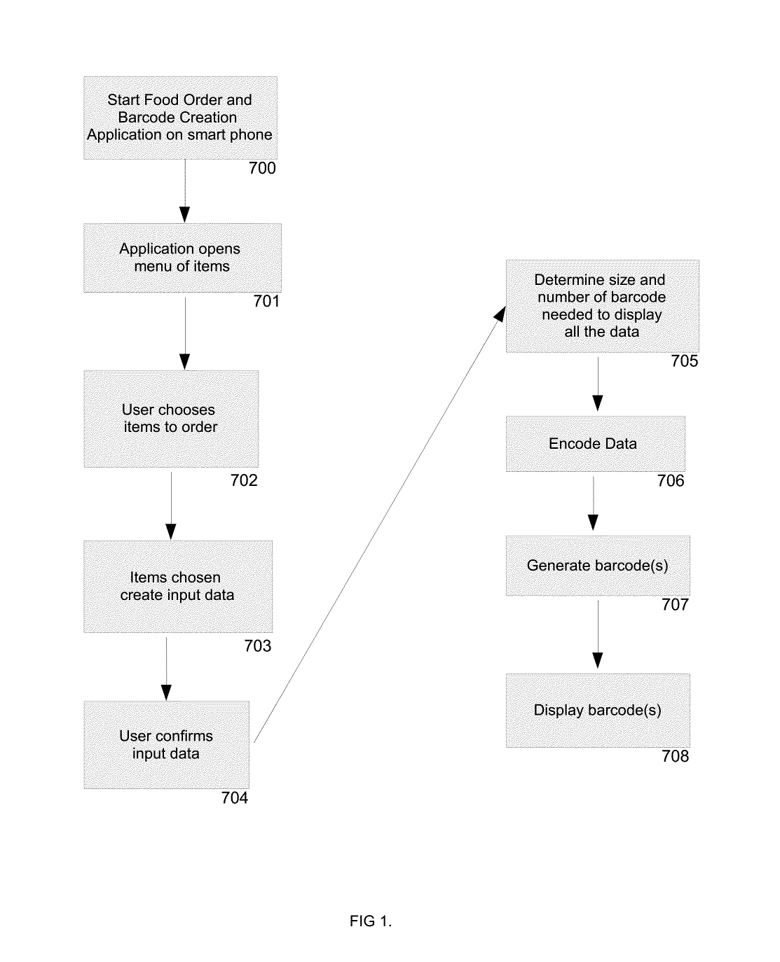

### FIGS. 1-4

Turning now to FIG. 1, step 700, the custom software application is accessed on the Smartphone. At step 701, the software application shows the menu items available for order. Next at step 702, the user creates their order from the menu items. At step 703, the software interprets the data into the correct format to encode into barcode format. At step 704, the user confirms the order and the software begins the barcode encoding process at step 705 by calculating the barcode or barcodes sizes and quantity needed to transfer the order. At step 706, the software encodes the barcode data to include the information from the user as well as barcode segmentation order and all data, the barcode is generated on the Smartphone at step 707 and finally at step 708 the barcode(s) is/are displayed on the Smartphone screen.

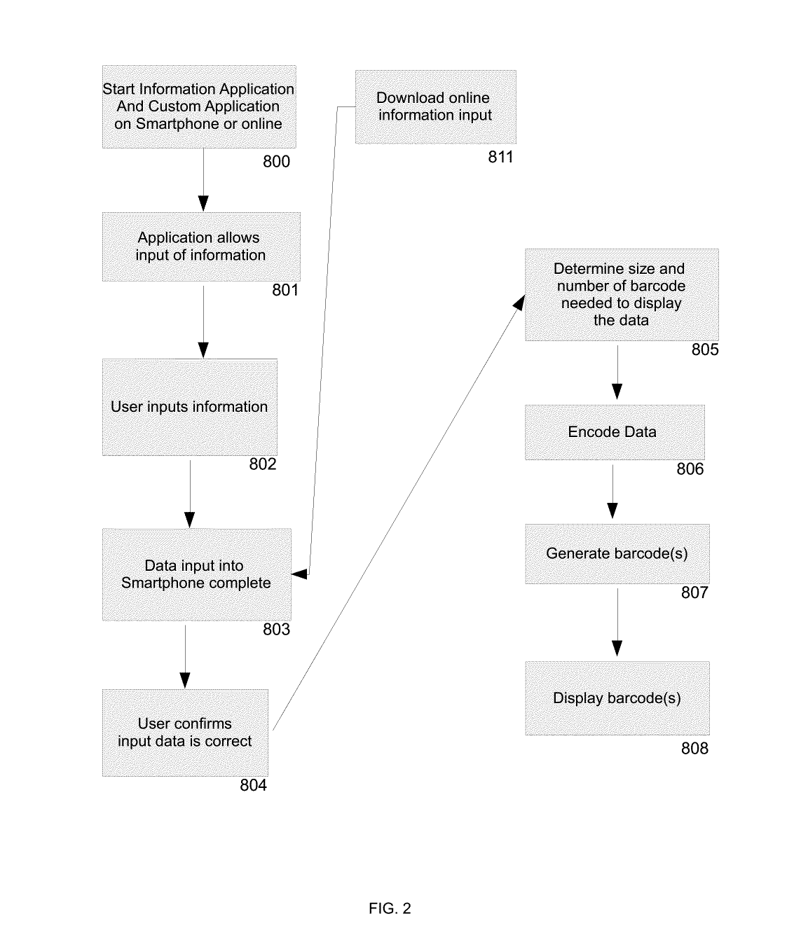

In FIG. 2 step 800, the custom software application is accessed. At step 801, the software application provides a means for the user to input their information, in step 802, the user inputs information, using the local Smartphone (or similar device) keyboard or other input method. At step 803, the software checks the software input is complete and meets the expected criteria or at step 811, the user has the option to download the data into the Smartphone app, which the user has input into an online or PC format. At step 804, the user confirms the order and the software begins the barcode encoding process at step 805 by calculating the barcode or barcodes sizes and quantity needed to transfer the order. At step 806, the software encodes the barcode data to include the information from the user as well as barcode segmentation order and all data, the barcode is generated on the Smartphone at step 807 and finally at step 808 the barcode(s) is/are displayed on the Smartphone screen.

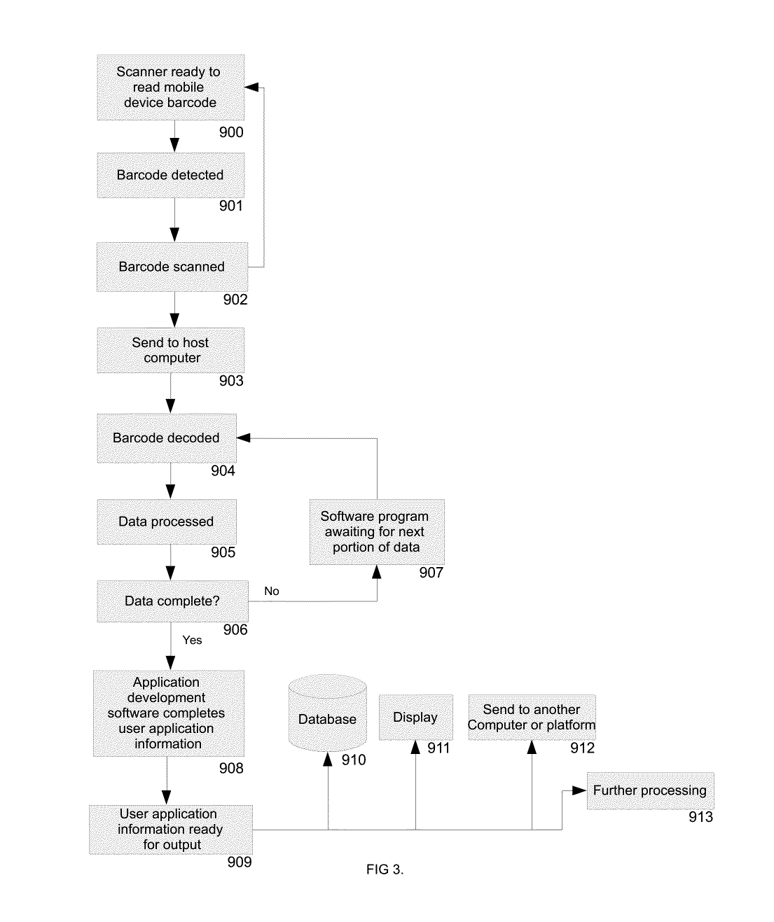

In FIG. 3, the recipient of the information takes place. A barcode reader, optical reader, camera or other device capable of reading the barcode information is ready to read at step 900. At step 901, the reading device detects a valid barcode, while at step 902, the reader scans the coded information and sends it to the host computer at step 903. At step, 904, the host computer decodes the information and processes the data at step 905. At step 906, the system checks if the data is complete or if there is another segment of information forthcoming. If there is further information needed to complete this transaction, at step 907 the system continues the previous steps 904, 905 and 906 for further information processing until complete. At 908, the host system software, completes the information transfer from the user and prepares for the next step, 909, where the information is sent to a database, at step 910, a display system at step 911, to another computer or platform in step 912 or finally to a memory state for other processing such as step 913.

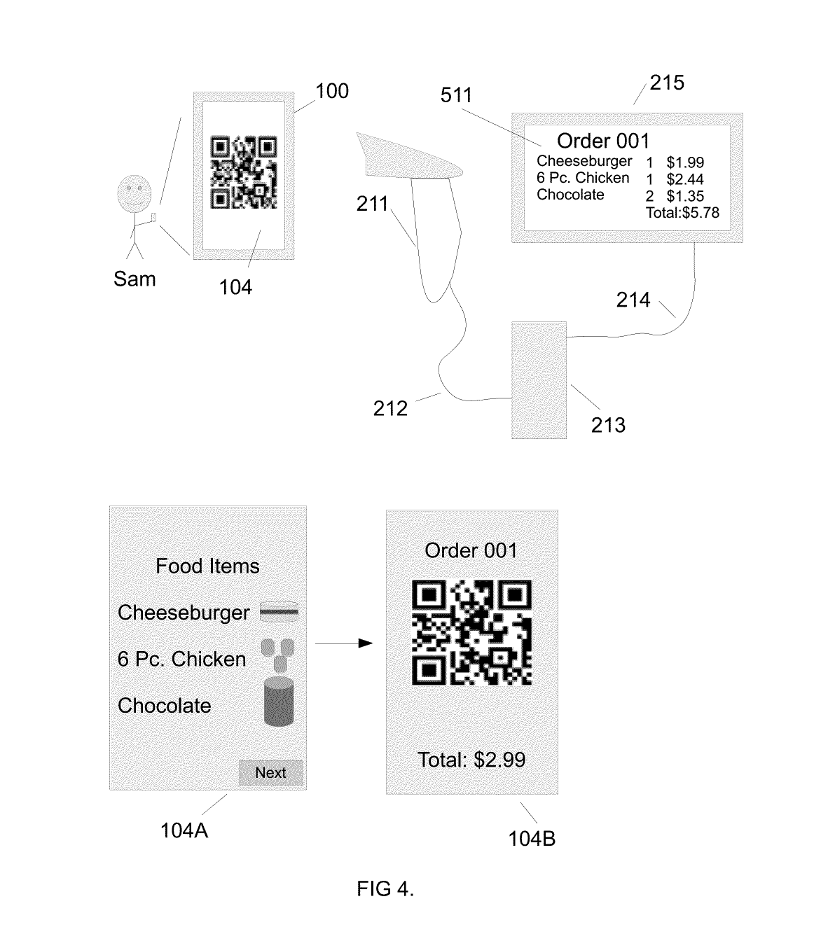

As shown in FIG. 4, this particular embodiment can be used as part of a fast food drive thru ordering system. The user in this case, SAM, demonstrates how having the barcode order ready as shown in 104, with their Smartphone (100), and the barcode reader (211) or similar, SAM is able to send his order in less time than either SAM or the order taker at the drive thru window can say salutations. The reader is usually connected by a cord (212) to the host computer (213) SAM is able to send his order in less time than either SAM or the order taker at the drive thru window can say salutations. The host computer then decodes and communicates that bar code data message to a display (215) system, database, and send to another host device such as a cash register, a point of sale system or another computer for further processing of the data (511). The scanner is hard wired (214) to the host computer, such as, for example, a USB connection or a RS-232 serial connection. Possible future enhancements may contain wireless communication from scanner to host computer.

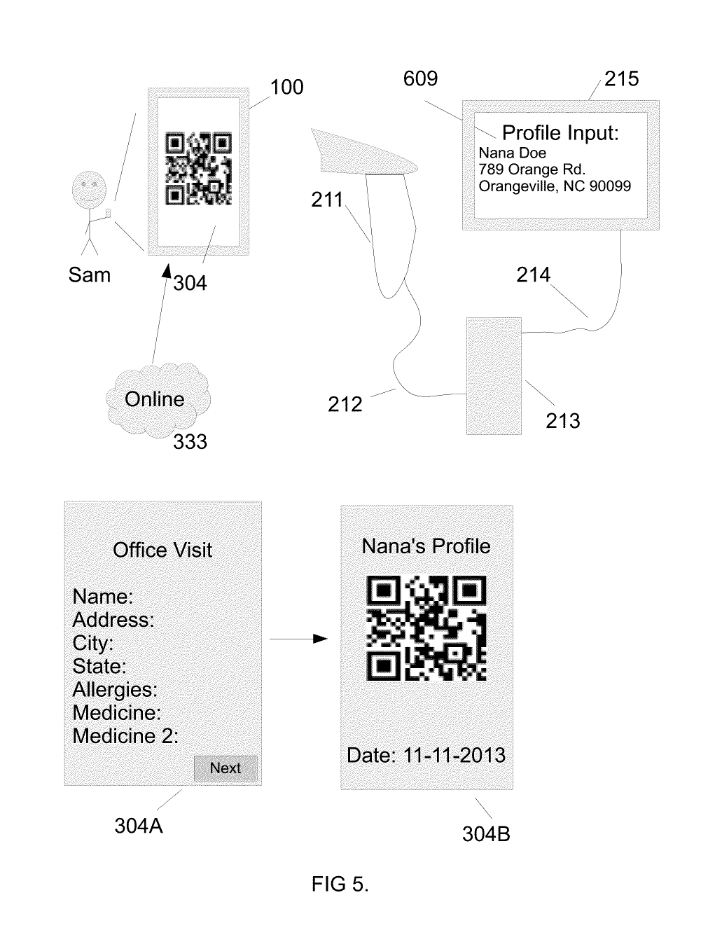

As shown in FIG. 5, an overview of any of the data input embodiments. The user in this case, SAM, demonstrates how having the barcode order ready as shown in 304, with their Smartphone (100), and the barcode reader (211) or similar, SAM is able to have his information (304A and 304B) for an application, ready and complete in quicker time than it takes to fill out form after form in a typical application process. The reader is usually connected by a cord (212) to the host computer (213). The host computer then decodes and communicates that bar code data message to a display (215) system, database, and send to another host device such as a cash register, a point of sale system or another computer for further processing of the data (609). The scanner is hard wired (214) to the host computer, such as, for example, a USB connection or a RS-232 serial connection. Possible future enhancements may contain wireless communication from scanner to host computer. An online database (333) would allow a user to complete the information on a regular PC or similar, and simply download to the Smartphone (100) and the custom software application (304).

### CONCLUSION, RAMIFICATIONS, AND SCOPE

Accordingly the reader will see that, according to one embodiment of the invention, I have provided a display device such as a Smartphone, cell phone, mobile device or portable computer to enter and display the barcode information.

While the above description contains many specificities, these should not be construed as limitations on the scope of any embodiment, but as exemplifications of various embodiments thereof. Many other ramifications and variations are possible within the teachings of the various embodiments. For example, other portable devices with a display such as a smartwatch can send or receive data a user wants to share using a barcode.

Thus the scope should be determined by the appended claims and their legal equivalents, and not by the examples.

I claim:

1. A method of transferring information using barcodes comprising the steps of: a customer accessing software on a device; barcode encoding based on customer/user input and information; a barcode reader or optical reading device from receiving side to receive said input and information; barcode reading data until transfer of said information is complete; processing; confirmation of successful transfer of said information; display or further processing of said information to point of sale, business system or other, whereby a customer/user can transfer information in a precise, efficient and speedy method.
